(19) United States
(12) Patent Application Publication
(10) Pub. No.: US 2002/0139291 A1
(43) Pub. Date: Oct. 3, 2002

(54) Ultimate bookmark

(76) Inventor: Will Tate Roundy, San Luis Obispo, CA (US)

Correspondence Address: DAVE MARTINDALE, 249 PATRICIA COURT, SAN LUIS OBISPO, CA, 93405, US

(21) Appl. No.: 09/861,978

(22) Filed: Apr. 2, 2001

(51) Int. Cl. B42D 9/00

(52) U.S. Cl. 116/234

(57) ABSTRACT

This Unique bookmark features ‘page finder’ detail markers, which may be printed with promotional, inspirational or interesting material. The bookmark assembly's of a size that fits within the pages of most books with minimal distortion to the book. The bookmark page finder is extracted and returned to the bookmark/page finder holder when not in use. The bookmark page finder may include non-permanent adhesive to attach to the page locating paragraphs for the reader. The detail page finder feature is combined with many page locator features including: 1˜Non-permanent adhesive to attach the bookmark assembly to any place in the book (including the outside of the book) without slipping. 2˜Optional ribbon from the bookmark as a page locator. 3˜Optional notepad integrated into the bookmark which may include one or sheets. 4˜Optional penholder, which attaches a writing instrument to the top or the side of the bookmark, that extends from the book when in use as a bookmark. 5˜Optional clip built into the bookmark to attach the bookmark to the book while using one of the other features to mark the place, or take notes.

### BACKGROUND OF THE INVENTION

1. Field of the Invention

The present invention, in general, to bookmarks and, more specifically, to bookmarks which are attached to the book or inserted in the book page cleavage for location or placement of the bookmark,

2. Description of Prior Art

Bookmarks are commonly used to mark a page location in a book where the reader has stopped reading. Typically bookmarks are in the form of a thin, planar member which is insertable between the pages of a book and can be removed from the book when the user desires to read the book.

Since most bookmarks are not attached to the book and they are usually removed from the book to proceed with reading from the page of the mark. The mark is readily misplaced with no specific storage for the mark.

To overcome this problem, bookmarks have been devised which include a clip which is permanently or detachably attached to the book. Such clips have been attached to or inserted in the spine of the book cover and carry a ribbon or thin cord to mark a page in the book. While obviating the possibility of losing the bookmark during reading, such attachable bookmarks have utilized complicated and therefore costly attachment means or clips which results in an increased manufacturing cost.

It is desirable to provide a bookmark, which is removable, yet conveniently stored to overcome the problem of misplacing the bookmarks and the lack of a convenient bookmark when the need for a bookmark arises.

### SUMMARY OF THE INVENTION

The invention is an assembly of the bookmark(s) and the bookmark body. The bookmark body is a rectangular shaped laminated plastic or similar material, which may be sandwiched to allow the insertion of the bookmark(s) for storage when not marking a place in the book.

The bookmark assembly is conveniently designed to allow the bookmark assembly to be placed in a book as a storage location for the bookmark assembly. Each bookmark is then removed from the bookmark assembly to mark the specific location in the book, as with other thin cleavage wedge bookmarks. Since the number of bookmarks may be as many as eight in each bookmark assembly the book reader can mark the book in as many as seven or more locations with a single bookmark assembly.

The bookmark may include a friction clip to attach the bookmark assembly to allow external mounting or bookmark assembly that mounts on the cover of the book.

The bookmarks may be decorated or plain. Typical decorations can include floral, sports, technical, written or the like. Written applications on the bookmarks can relate to each other such as inspirational messages, trivia, or advertisement for a business.

### BRIEF DESCRIPTION OF DRAWING

The various features, advantages and other uses of the present invention will become apparent by referring to the following detailed description and drawing in which:

FIG. 1 is the elevation view of the bookmark, which is from 3 to 8 inches in length, and from 1 inch to

4 inches wide with the most common dimensions of 2 inches wide by 6 inches long with bookmark storage slits, 1 inch wide. The bookmark body thickness ranges from, 003 inches up to 0.125 inches thick, subject to the specific use intended.

FIG. 2 is the bookmark that is typically plastic or similar material, which may be of various configurations that allow placement in the bookmark housing. The configuration depicted has a stem, which is approximately 1 inch wide and 5 inches long with a semi oval top for gripping by the fingers to remove from the body assembly or insert the bookmark in the body assembly. The bookmark is made from plastic or similar material that is thin, light and rigid. The bookmark has a thickness from 0.002 to 0.020 depending on the specific ultimate use and materials of construction.

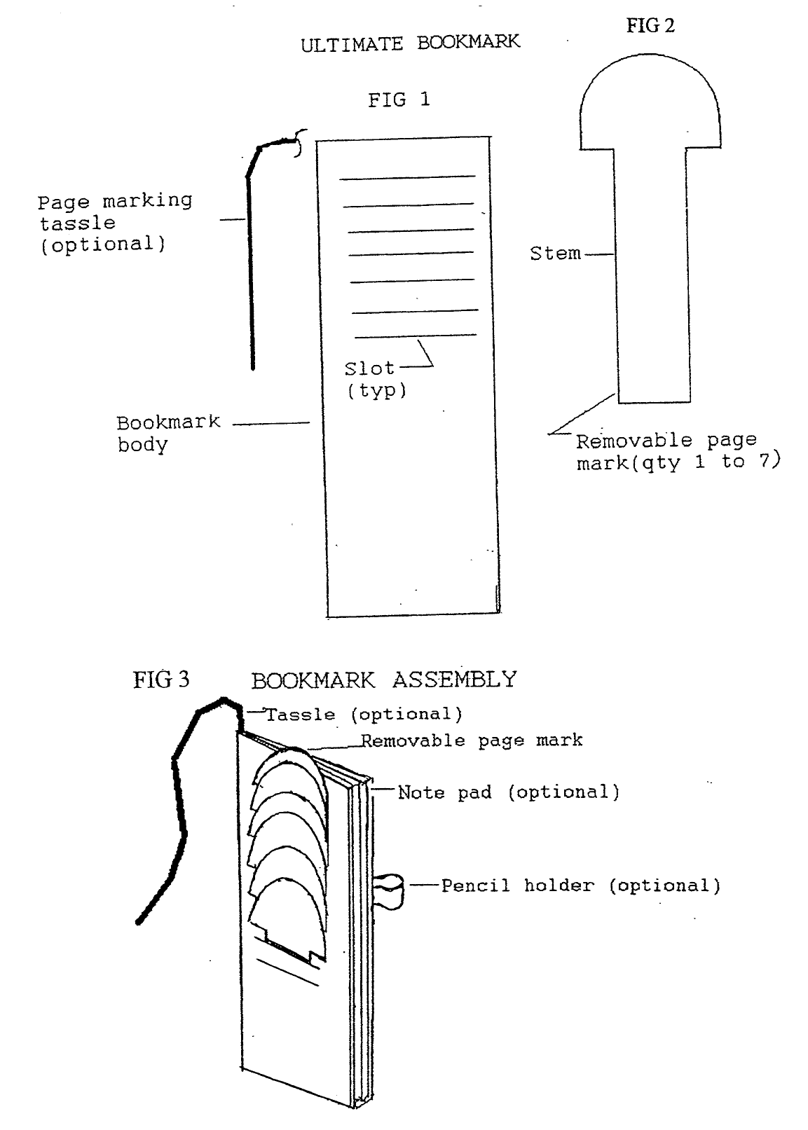

What is claimed:

1 The bookmark assembly includes one or more parts that are initially assembled together comprising the bookmark assembly. (See FIG. 3.)

2 The bookmark assembly includes one or more page markers (see FIG. 2), which are removed from the bookmark assembly to mark a reader's progress or a specific page location for any reason.

3 The page markers can be easily removed and returned to the assembly for easy retention of the page markers and insure high utility.

4 The page markers are usually, but not necessarily made from laminated plastic or paper. The ‘head’ portion of the bookmark may be various shapes, such as oval, round, rectangular or any other configuration.

5 The bookmark assembly is designed to be made from thin material generally not exceeding 0.1 inches thick and most models are designed 0.05 inches thick or less. This allows the bookmark assembly to be placed in the book as a marker without excessive separation of the book pages when closed.

6 The page markers are of a minimum thickness on the order of 0.05 inches or less to allow construction of the bookmark assembly of minimum thickness with all pages markers placed in the assembly.

7 The typical width of the bookmark assembly is 1 inch up to 4 inches wide and 3 inches up to 8 inches long, depending on the specific application planned for the bookmark assembly.

8 The page markers usually slide into slits in the bookmarker assembly, which allows the user easy access to a specific page marker for use in marking the book.
Typical Uses:

9 The bookmark assembly may be placed in any book, which has one, or more desired spots for reference. Any marker can be removed from the bookmark assembly and placed at a specific location in the book.

10 The page markers may be designed with attractive designs to appeal to the user, or marked with any sort of word phrases that will appeal to the user, such as; personal motivational statements, inspirational statements, sports references, advertising or other useful printing. The shape of the marker head may be varied to reflect different interests such as sports equipment, religious, tools or any conceivable representation.
Optional Designs that are Included in the Concept of the Ultimate Bookmark Assembly.

11. The bookmark may have all the standard features expect include an adhesive to attach the bookmark to the outside of the book while using the individual page markers to mark specific locations in the book, the adhesive may be semi permanent or reusable type for the intent of this application.

12 The bookmark may include all of the features of the basic claim and include a marker such as a pen or pencil which is attached to the bookmark assembly when the attachment point is outside the pages either vertically or horizontally attached to the bookmark when the book is closed.

13. The bookmark may include all of the features of the basic claim and include a strand, which is attached to the bookmark assembly when the attachment point is outside the pages when the book is closed and the strand may be used as a marker of flag in addition to the page markers described.

14. The bookmark may include all of the features of the basic claim and include a note pad folded between the outer and inner portion of the bookmark assembly. The note pad may be from a reusable surface of several sheets of paper that may be marked and removed one at a time while still maintaining a very thin bookmark assembly.

15. The bookmark may include a clip to attach the bookmark assembly to the book or other attachable object.
